(19) United States
(12) Patent Application Publication
(10) Pub. No.: US 2016/0379248 A1
(43) Pub. Date: Dec. 29, 2016

(54) PRESENTING OPPORTUNITIES FOR INSTANT TRANSACTIONS

(71) Applicant: Amazon Technologies, Inc., Seattle, WA (US)

(72) Inventors: Jeffrey Ross Panaguiton Damian, Seattle, WA (US); Sandeep Bodapti, Renton, WA (US); Cheryl Staab Friedman, Seattle, WA (US); Jason William Levine, Renton, WA (US); Sree Kalyan Chakravorty Mamidi, Issaquah, WA (US); Nicolas Jean Mottet, Seattle, WA (US); Vikram Singh, Mercer Island, WA (US)

(21) Appl. No.: 14/752,201

(22) Filed: Jun. 26, 2015

(51) Int. Cl. G06Q 30/02; G06Q 20/10; G06Q 30/06

(52) U.S. Cl. CPC G06Q 30/0253; G06Q 30/0633; G06Q 20/10

(57) ABSTRACT

In some examples, a customer is identified that is associated with an item that is eligible for instant sell. The item may be eligible for instant sell because the item is popular on an electronic marketplace. A selling opportunity for the customer to sell the item may be presented to the customer. The selling opportunity may include an offer to sell the item via an instant payment transaction when the customer is qualified for the instant payment transaction. The instant payment transaction may enable the customer to receive instant credit for accepting the terms of the offer. A selection indicating acceptance of the offer by the customer may be received and, in response, a notification may be provided to the customer.

### BACKGROUND

Databases may be configured to store time information and item information regarding transactions. The time information may be accessed in order to determine when a new transaction relating to the item should be performed. Details about the new transaction may be automatically presented to a user via a webpage so that the user can decide whether to conduct the transaction.

### BRIEF DESCRIPTION OF THE DRAWINGS

Various embodiments in accordance with the present disclosure will be described with reference to the drawings, in which:

FIG. 1 is an example block diagram for implementing techniques relating to selling items in connection with an electronic marketplace as described herein, according to at least one example;

FIG. 2 is an example schematic architecture for implementing techniques relating to selling items in connection with an electronic marketplace as described herein, according to at least one example;

FIG. 3 is an example device for implementing techniques relating to selling items in connection with an electronic marketplace as described herein, according to at least one example;

FIGS. 4-9 are example user interfaces for implementing techniques relating to selling items in connection with an electronic marketplace as described herein, according to at least one example;

FIG. 10 is an example flow diagram for implementing techniques relating to selling items in connection with an electronic marketplace as described herein, according to at least one example;

FIG. 11 is an example flow diagram for implementing techniques relating to selling items in connection with an electronic marketplace as described herein, according to at least one example;

FIG. 12 is an example flow diagram for implementing techniques relating to selling items in connection with an electronic marketplace as described herein, according to at least one example; and

FIG. 13 is an example schematic environment for implementing techniques relating to selling items in connection with an electronic marketplace as described herein, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present description are directed to, among other things, techniques relating to presenting opportunities for customers of an electronic marketplace to sell their used items in connection with the electronic marketplace. This may enable the customers to obtain residual income for items that they are no longer using. The customers may be prompted to sell the items or may indicate their desire to sell. Using techniques described herein, for example, a customer who purchased a laptop a year or more ago may be presented with an opportunity to sell the laptop. The time at which the selling opportunity is presented to the customer may be a time at which customers generally sell or trade in similar laptops (e.g., after one year of ownership). The customer may or may not have previously requested receipt of the selling opportunity. Various selling opportunities are described herein, each may include an offer, terms of acceptance, and possible prices. For example, an instant sell transaction is a type of a selling opportunity. The instant sell transaction may include an offer for the customer to sell the item to an unidentified purchasing party. The unidentified purchasing party may be a third-party merchant who has submitted a bid to purchase the customer's laptop via a bidding platform hosted by the electronic marketplace. The electronic marketplace may act as a broker to facilitate exchange of the laptop and payment between the customer and the purchasing party. The customer may receive payment after the condition of the item is verified and after the purchasing party receives the laptop. When the customer is a qualified customer (i.e., a customer who has a low fraud risk profile), however, the instant sell transaction may also include an option for instant payment. If the customer accepts an offer including instant payment, the electronic marketplace may credit an account of the customer prior to verification of the condition of the item and prior to the customer event sending the item to the purchasing party. The credit received via instant payment may be immediately available for use by the customer (e.g., in the form of a gift card useable in connection with the electronic marketplace).

Turning now to a particular example, in this example, an electronic marketplace may maintain a database of items eligible to be instantly sold. These are generally popular items that retain a commercial value even though they have been used. The electronic marketplace may also maintain a database of customers. Some of the customer may be customers who are pre-qualified to sell items via instant payment. These are customers who have been identified as having low fraud risk profiles (i.e., trustworthy customers), or who have not yet exhibited behavior indicative of a fraud risk. The electronic marketplace may provide a platform for merchants to bid on the eligible items. For example, the merchants may bid on a particular laptop model (e.g., Brand L, model T) of a particular condition (e.g., like new). Meanwhile, the electronic marketplace may identify a customer that has previously purchased a brand L, model T laptop, or receive an indication from a customer through the electronic marketplace that the customer possesses the item and is interested in investigating possibly selling the item. The electronic marketplace may request that the customer indicate a condition of the laptop. In response, the electronic marketplace may present to the customer a list of selling opportunities. The list of selling opportunities may be different channels by which the customer may dispose of the laptop. Each of the selling opportunities may identify the customer's brand L, model T laptop and may be associated with different prices based on the condition of the laptop, the amount of risk the customer is taking on, and the level of convenience for the customer. One of the selling opportunities may include an option for an instant sell transaction including instant payment. Selection of the instant sell transaction including instant payment may enable the customer to sell her laptop in exchange a fixed payment amount equal to one of the bids (e.g., a highest bid). In some examples, the instant sell transaction may also include an option for instant credit. The option for instant credit may be offered to qualified customers and, when selected, may enable the customer to immediately redeem the fixed payment amount (i.e., without having to wait to send her laptop in and have the quality assessed). For example, such immediately-redeemable credit may come in the form of a gift card that is immediately redeemable in connection with the electronic marketplace. This may enable the customer to use the instant credit to immediately purchase other items on the electronic marketplace without having to wait for verification of receipt of her laptop by the electronic marketplace (or its agent). Terms and conditions of the instant sell transaction, however, may indicate that to retain the full amount of the instant credit, the customer's brand L, model T laptop must be in the condition specified and must be shipped within a fixed time period (e.g., 7 days). Once the laptop is received, the condition is verified by a condition entity. If the actual condition corresponds to the specified condition, the customer may retain the total amount of the instant credit and an entity that manages the electronic marketplace, which up to this point has paid for the laptop (i.e., via the instant credit), may inform the merchant that submitted the winning bid that it has won the laptop, bill the merchant for the price of the laptop together with any other fees, and provide for transfer of the laptop to the merchant. The merchant may then offer the laptop for sale via the electronic marketplace, may keep it, or may offer it for sale through another sales channel of its choosing (i.e., through another electronic marketplace or a physical location). If, however, the condition of the laptop is of poorer than specified, the customer may be responsible to pay back the difference to the entity managing the electronic marketplace. This may come in the form of a debit to the customer's account or a credit instrument associated with the customer's account.

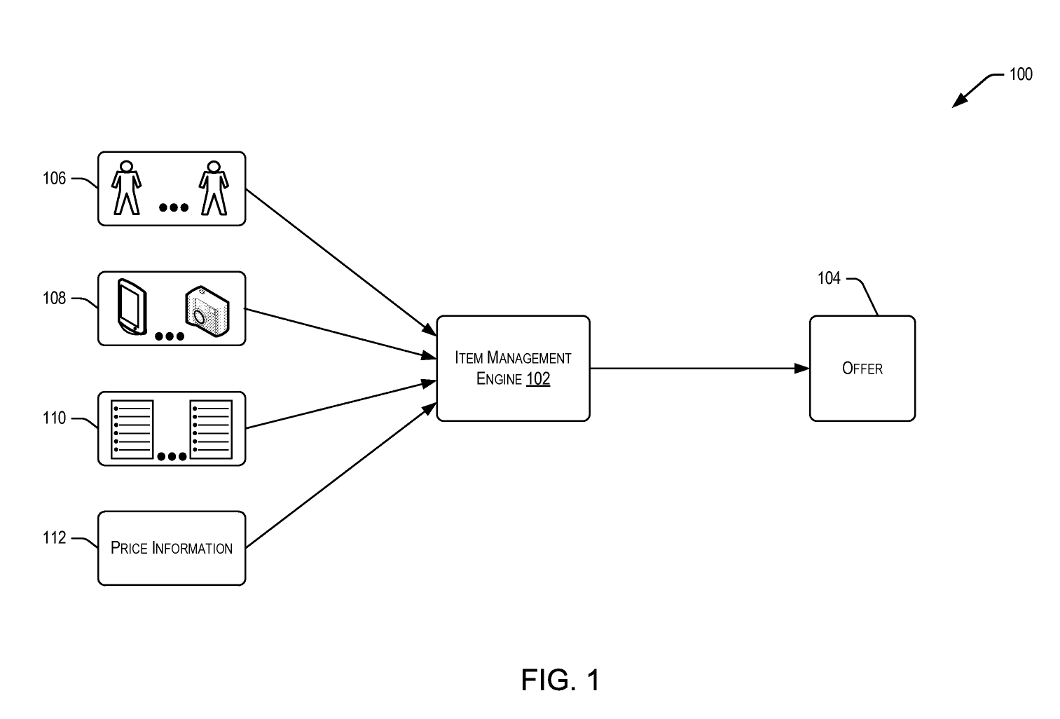

Turning now to the figures, FIG. 1 illustrates an example block diagram depicting environment 100 for implementing techniques relating to selling items in connection with an electronic marketplace, as described herein. In particular, the environment 100 may include an item management engine 102. As described herein, the item management engine 102 may be included as part of an electronic marketplace to implement the techniques described herein. The item management engine 102 may be configured to access certain information, which may be local to the item management engine 102 or received from other computing devices, in order to determine an offer 104 for a customer to sell an item. The item management engine 102 may access or receive customer information 106, item information 108, item condition information 110, and price information 112. As used herein, the term “item,” in addition to having its ordinary meaning, is used interchangeably to refer to an item itself (e.g., a particular product) and to its description or representation in a computer system or electronic catalog. As will be apparent from the context in which it is used, the term is also sometimes used herein to refer only to the item itself or only to its representation in the computer system.

The customer information 106 may identify one or more customers of the electronic marketplace. In some examples, the customer information 106 may identify customers that are qualified to participate in instant sell transactions including instant payment, all customers of the electronic marketplace, or customers that are not qualified to participate in instant sell transactions. The qualified customers may be qualified by a fraud detection service as having low fraud risk profiles. In other words, the qualified customers may have characteristics of trustworthy customers. In some examples, whether or not a customer is qualified may depend on other factors besides just the customer's trustworthiness. The disqualified customers may be disqualified by the fraud detection service as having high fraud risk profiles. These may be customers who do not exhibit characteristics of trustworthiness.

The item information 108 may identify one or more items that are eligible to be sold by customers identified by the customer information 106 on the electronic marketplace. The one or more eligible items may include used items for which there is a high resell demand. The high resell demand may be determined by monitoring active bids for the one or more eligible items by third-party merchants or a purchasing entity of the electronic marketplace. For example, as illustrated, electronic devices (e.g., cell phones, cameras, laptops, computer, and other electronic devices) may be examples of the one or more eligible items. The item information 108 may also identify historical resell and trade-in information for items. For example, the item information 108 may indicate, for at least some of the items, a lifetime. The lifetime may be an average time, in terms of days, weeks, years, or the like, from when an item is purchased until the item is sold, traded in, or otherwise disposed of. In some examples, the item information 108 may be organized according to categories of items. For example, even if historical resell or trade-in information does not exist for a particular item (e.g., a model XYZ cell phone), the item information 108 may include historical resell or trade-information for the category of electronics, which may include one or more subcategories of electronics (e.g., mobile devices, laptops, speakers, desktop computers, and any other category of electronics). In some examples, categories may correspond to one or more departments of the electronic marketplace. For example, the categories may include electronics and computers, home, garden, and tools, beauty, health, and grocery, toys, kids, and baby, clothing, shoes, and jewelry, sports and outdoors, automotive and industrial, and any other suitable category.

The item condition information 110 may identify the condition of the one or more items identified by the item information 108. In some examples, because the item condition information 110 may relate directly to particular items identified by the item information 108, the item condition information 110 may be entered manually into a suitable interface, or otherwise provided to the item management engine 102 by a customer in possession of the particular items. For example, the item condition information 110 may be provided to the item management engine 102 in response to the item management engine 102 requesting such information from a customer desiring to a sell an eligible item. The price information 112 may identify one or more market prices for the one or more items identified by the item information 108. In some examples, the price information 112 may be derived, in part, from one or more merchant bids received from merchants desiring to purchase the one or more items identified by the item information 108, and of the specified condition. For example, the price information 112 may identify that a merchant is willing to pay $100 for an eligible item of a certain condition.

Based at least in part on the information provided to or accessed by the item management engine 102, the item management engine 102 may determine the offer 104. The offer 104 may be an example of a selling opportunity. The offer 104 may include an offer to a customer to instantly sell an item identified by the item information 108 via the electronic marketplace in exchange for delayed guaranteed consideration. The consideration, however, may be available to the customer only after the item has been received and the condition of the item has been verified. Such an instant sell transaction may be available to all or mostly all customers of the electronic marketplace. For example, customers who are disqualified may not be able to sell items using instant sell transactions because doing so would present too large of a risk to a management entity of the electronic marketplace.

In some examples, the offer 104 may include an offer to a customer to instantly sell an item via the electronic marketplace in exchange for instant guaranteed consideration. The consideration may be instant because it is available to the customer immediately after the customer accepts the offer. Such an instant sell transaction including instant payment may be available to only customers who are qualified. Limiting these offers may be desirable so that the management entity of the electronic marketplace may limit its exposure to the risk that the customer will not send in the item, even after accepting the offer. This is because the management entity agrees to carry the cost of the item instantly paid to the customer until the item's condition has been verified and the item has been provided to a purchasing party. Once the purchasing party receives the item, the purchasing party may pay the management entity their agreed-upon price. When the purchasing party is one of the merchants, the agreed-upon price may correspond to a bid for the item made by the merchant. In some examples, the merchants may include third-party sellers of the electronic marketplace, a purchasing entity of the electronic marketplace, and any other entity capable of purchasing and selling items. The purchasing entity of the electronic marketplace may be an entity associated with the electronic marketplace that buys and sells items.

In some examples, in addition to the offer 104 or in the place of the offer 104, the item management engine 102 may present other selling opportunities to the customer. For example, regardless of whether the customer is qualified or the item is eligible, the user may be provided a selling opportunity including a consignment transaction. In accordance with the consignment transaction, the customer may allow the electronic marketplace to sell the item on behalf of the customer via a consignment arrangement (e.g., a selling party receives a commission of the sale price). The sale price for the consignment transaction may be determined based on existing items being sold via the electronic marketplace and historical information for items previously sold via the electronic marketplace. Another example selling opportunity may include a sell on own transaction. Regardless of whether the customer is qualified or the item is eligible, the customer may be provided with the selling opportunity including the sell on own transaction. In accordance with the sell on own transaction, the customer may be allowed to sell the item via the electronic marketplace on her own behalf. This may include the customer listing the item on the electronic marketplace, determining suitable price for the item, and any other action in order to sell the item.

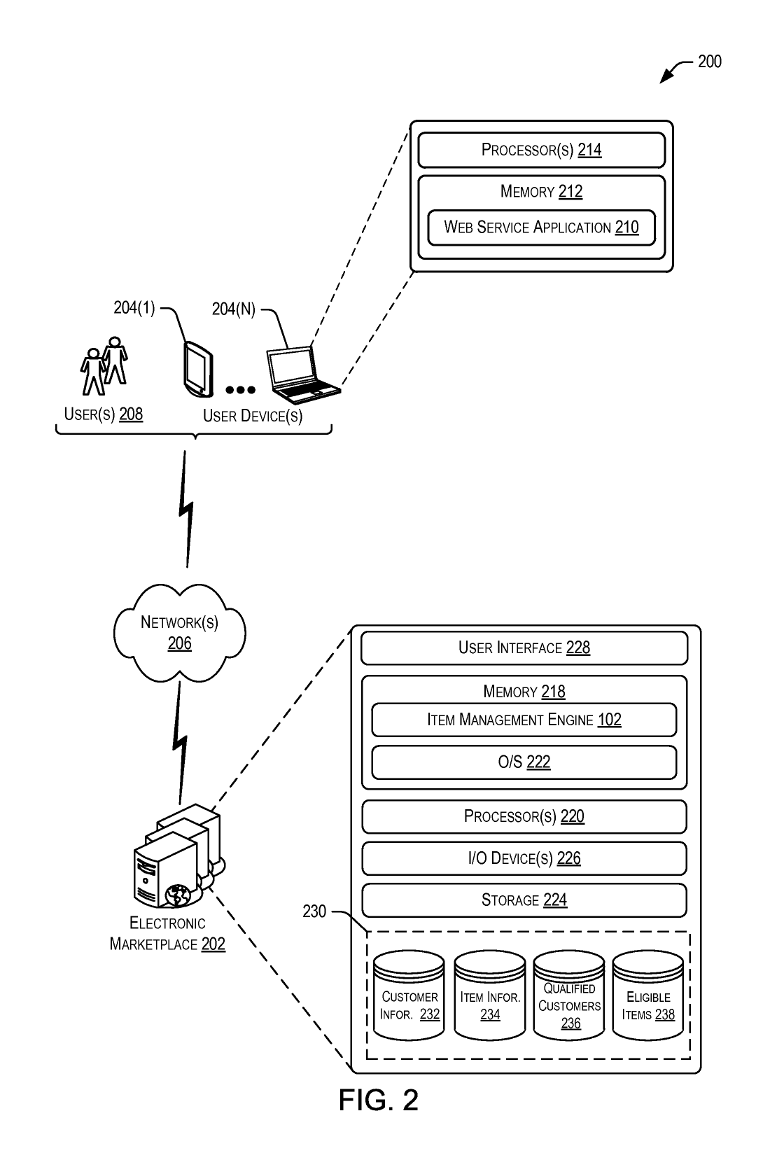

FIG. 2 illustrates an example architecture 200 for implementing techniques relating to selling items in connection with an electronic marketplace as described herein. The architecture 200 may include an electronic marketplace 202 in communication with one or more user devices 204(1)-204(N) (hereinafter, “the user device 204”) via one or more networks 206 (hereinafter, “the network 206”). The user device 204 may be operable by one or more users 208 (hereinafter, “the user 208”) to interact with the electronic marketplace 202. The network 206 may include any one or a combination of many different types of networks, such as cable networks, the Internet, wireless networks, cellular networks, and other private and/or public networks. The user 208 may be any suitable user including, for example, customers of the electronic marketplace 202 and merchants associated with the electronic marketplace 202.

Turning now to the details of the user device 204, the user device 204 may be any suitable type of computing device such as, but not limited to, a digital camera, a wearable device, a tablet, a mobile phone, a smart phone, a personal digital assistant (PDA), a laptop computer, a desktop computer, a thin-client device, a tablet computer, a set-top box, or any other suitable device capable of communicating with the electronic marketplace 202 via the network 206 or any other suitable network. For example, the user device 204(1) is illustrated as an example of a smart phone, while the user device 204(N) is illustrated as an example of a laptop computer.

The user device 204 may include a web service application 210 within memory 212. Within the memory 212 of the user device 204 may be stored program instructions that are loadable and executable on processor(s) 214, as well as data generated during the execution of these programs. Depending on the configuration and type of user device 204, the memory 212 may be volatile (such as random access memory (RAM)) and/or non-volatile (such as read-only memory (ROM), flash memory, etc.). The web service application 210, stored in the memory 212, may allow the user 208 to interact with the electronic marketplace 202 via the network 206. Such interactions may include, for example, searching a database of items, adding items to a virtual cart, providing for payment of items, managing user preferences associated with the user 208 and/or any of the user devices 204, accepting offers for resell of items, listing used or new items for sale, providing bids to purchase used items, and any other suitable client-server interactions. The electronic marketplace 202 may host the web service application 210.

Turning now to the details of the electronic marketplace 202, the electronic marketplace 202 may include one or more service provider computers, perhaps arranged in a cluster of servers or as a server farm, and may host web service applications. These servers may be configured to host a website (or combination of websites) viewable on the user device 204 (e.g., via the web service application 210). Items that may be purchased, rented, or otherwise accessed on the electronic marketplace 202 may be presentable to the user 208 via the web service applications. The electronic marketplace 202 may be associated with one or more physical locations used to house items associated with the electronic marketplace 202. For example, while the electronic marketplace 202 may provide for a digital experience for users 208 to search for and procure items, the electronic marketplace 202 may also be associated with one or more warehouses for housing certain items while they are being offered in connection with the electronic marketplace. In some examples, the items include items owned by an operator of the electronic marketplace 202 and third parties.

The electronic marketplace 202 may include at least one memory 218 and one or more processing units (or processor(s)) 220. The processor 220 may be implemented as appropriate in hardware, computer-executable instructions, software, firmware, or combinations thereof. Computer-executable instruction, software, or firmware implementations of the processor 220 may include computer-executable or machine-executable instructions written in any suitable programming language to perform the various functions described. The memory 218 may include more than one memory and may be distributed throughout the electronic marketplace 202. The memory 218 may store program instructions that are loadable and executable on the processor(s) 220, as well as data generated during the execution of these programs. Depending on the configuration and type of memory including the electronic marketplace 202, the memory 218 may be volatile (such as random access memory (RAM)) and/or non-volatile (such as read-only memory (ROM), flash memory, or other memory). The memory 218 may include an operating system 222 and one or more application programs, modules, or services for implementing the features disclosed herein including at least the item management engine 102.

The electronic marketplace 202 may also include additional storage 224, which may be removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The additional storage 224, both removable and non-removable, are examples of computer-readable storage media. For example, computer-readable storage media may include volatile or non-volatile, removable or non-removable media implemented in any suitable method or technology for storage of information such as computer-readable instructions, data structures, program modules, or other data. As used herein, modules, engines, and components, may refer to programming modules executed by computing systems (e.g., processors) that are part of the electronic marketplace 202 and/or the user device 204.

The electronic marketplace 202 may also include input/output (I/O) device(s) and/or ports 226, such as for enabling connection with a keyboard, a mouse, a pen, a voice input device, a touch input device, a display, speakers, a printer, or other I/O device.

The electronic marketplace 202 may also include a user interface 228. The user interface 228 may be utilized by an operator or other authorized user to access portions of the electronic marketplace 202. In some examples, the user interface 228 may include a graphical user interface, web-based applications, programmatic interfaces such as application programming interfaces (APIs), or other user interface configurations. The electronic marketplace 202 may also include a data store 230. In some examples, the data store 230 may include one or more data stores, databases, data structures, or the like for storing and/or retaining information associated with the electronic marketplace 202. Thus, the data store 230 may include databases, such as a customer information database 232, an item information database 234, a qualified customer information database 236, and an eligible item information database 238.

The customer information database 232 may be used to retain information pertaining to customers and merchants of the electronic marketplace 202, such as the user 208. Such information may include, for example, customer account information (e.g., electronic profiles for individual users), demographic information for customers, payment instrument information for customers (e.g., credit card, debit cards, bank account information, and other similar payment processing instruments), account preferences for customers, shipping preferences for customers, purchase history of customers, and other similar information pertaining to a particular customer and sets of customers, of the electronic marketplace 202. In some examples, the information retained in the customer information database 232 may include default information for a customer or group of customers based on purchase history associated with the customer or group of customers. The default information may be used to establish a baseline for a new customer. The customer information database 232 may include information for all customers and merchants of the electronic marketplace 202. In some examples, the customer information database 232 may include a list of disqualified customers, list of qualified customers, and any other suitable distinction between customers. In some examples, the purchase history for a customer may be used to determine a list of items that are eligible for instant sell. Thus, the list of items may be populated from the purchase history of the customer. Once the list of items has been determined, it may be shared with the customer in any suitable manner. This may include a possible amount for each item and a total amount for all items. Such an arrangement may encourage customers to sell their used items via the electronic marketplace. The purchase history may also be used to determine if the customer has a valid credit card. Such information may be used to lower the customer's fraud risk profile. In some examples, this may enable the customer to be qualified to sell items via instant sell including instant payment.

The item information database 234 may be used to retain all items available for procurement via the electronic marketplace 202. These items may be organized in a manner that is searchable by the user 208. In some examples, the items are organized by categories, subcategories, and the like. For example, a category may be electronics and subcategories within electronics may be, among others, laptops, cell phones, and gaming devices. In some examples, the item information database 234 may include items available for procurement via the electronic marketplace 202 and fulfilled by the electronic marketplace 202, items available for procurement via the electronic marketplace 202 but fulfilled by an entity other than the electronic marketplace 202, and items unavailable on the electronic marketplace 202 and fulfilled by an entity other than the electronic marketplace 202.

The qualified customer information database 236 may be used to retain customers (i.e., “qualified customers”) that have been qualified to participate in certain services provided by the electronic marketplace 202. For example, the qualified customers may be qualified to participate in instant sell transactions offered by the electronic marketplace 202. The qualified customers in the qualified customer information database 236 may be a subset of the customers from the customer information database 232. Similar to the customer information database 232, the qualified customer information database 236 may include information associated with each of the qualified customers. The associated information may include, purchase history information (e.g., information capable of identifying purchased history for each item and/or transaction associated with the customers' accounts), trust information (i.e., information used to determine that the customers are qualified), and any other suitable associated information.

The eligible item information database 238 may be used to retain items that have been determined eligible (i.e., “eligible items”) for use in certain services provided by the electronic marketplace 202. For example, the eligible items may be eligible for use in connection with an instant sell transaction offered by the electronic marketplace 202. In some examples, the eligible items may be a subset of the items included in the item information database 234. The items may be determined as eligible in accordance with techniques described herein. In some examples, the eligible item information database 238 may include item identifiers (e.g., uniform product code (UPC), Amazon Standard Identification Number (ASIN), and the like) item description, and any other suitable information.

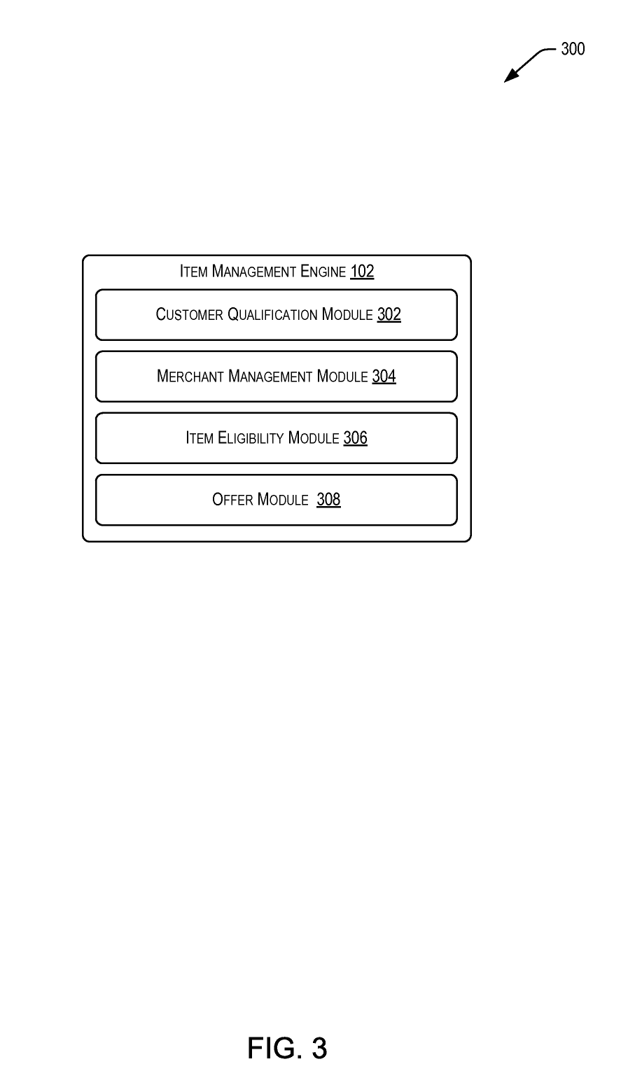

FIG. 3 illustrates an example device 300 including the item management engine 102. The item management engine 102 may be configured to manage one or more sub-modules, components, and/or services directed to examples disclosed herein. In some examples, the item management engine 102 may include a customer qualification module 302, a merchant management module 304, an item eligibility module 306, and an offer module 308. While these modules are illustrated in FIG. 3 and will be described as performing discrete tasks with reference to the flow charts, it is understood that FIG. 3 illustrates example configurations and other configurations performing other tasks and/or similar tasks as those described herein may be implemented according to the techniques described herein. Other modules, components, or engines may perform the same tasks as the item management engine 102 or other tasks, they each may be implemented in a similar or different fashion.

The customer qualification module 302 may be configured to determine one or more customers that are qualified. The merchant management module 304 may be configured to manage aspects of communication with one or more merchants. For example, the merchant management module 304 may enable the one or more merchants to provide merchant bids to the electronic marketplace 202. The merchant management module 304 may also be used to inform the one or more merchants when bids are accepted. The item eligibility module 306 may be configured to determine one or more items that are eligible. An item may be determined eligible based on popularity of the item, purchase history of the item by a customer, and any other aspects relating to the item, as described herein. As described herein, the popularity, purchase history, and other aspects may be defined by item categories. The offer module 308 may be configured to generate offers for customers to instantly sell or otherwise dispose of items in their possession. To this end, the offer module 308 may identify one or more purchase opportunities which may be presented to customers.

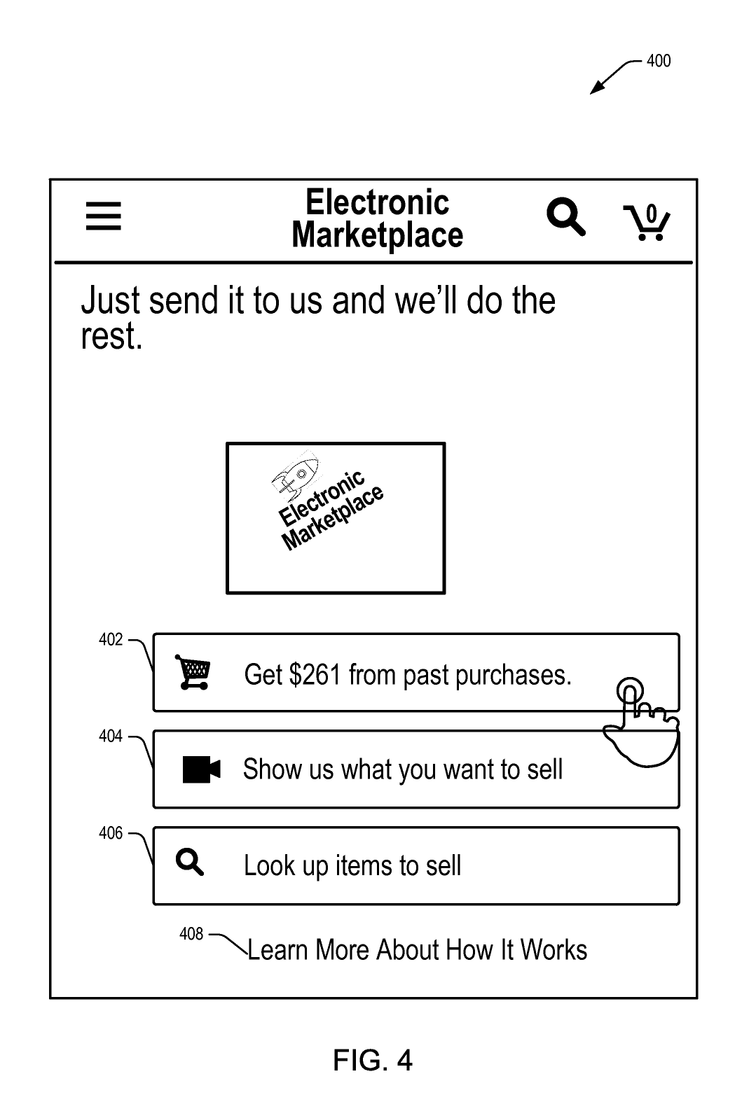

FIG. 4 illustrates an example user interface 400 for implementing techniques relating to selling items in connection with an electronic marketplace as described herein. In particular, the user interface 400 may be a web-based user interface provided by the electronic marketplace 202 for presentation on the user device 204. In some examples, the user interface 400 may be provided after a customer logs in to an account associated with the electronic marketplace 202. In this manner, the electronic marketplace 202 may provide content (e.g., the user interface 400) that is customized to the customer. In some examples, the user interface 400, including options 402-406, may be provided to customers that are qualified to instantly sell items as described herein.

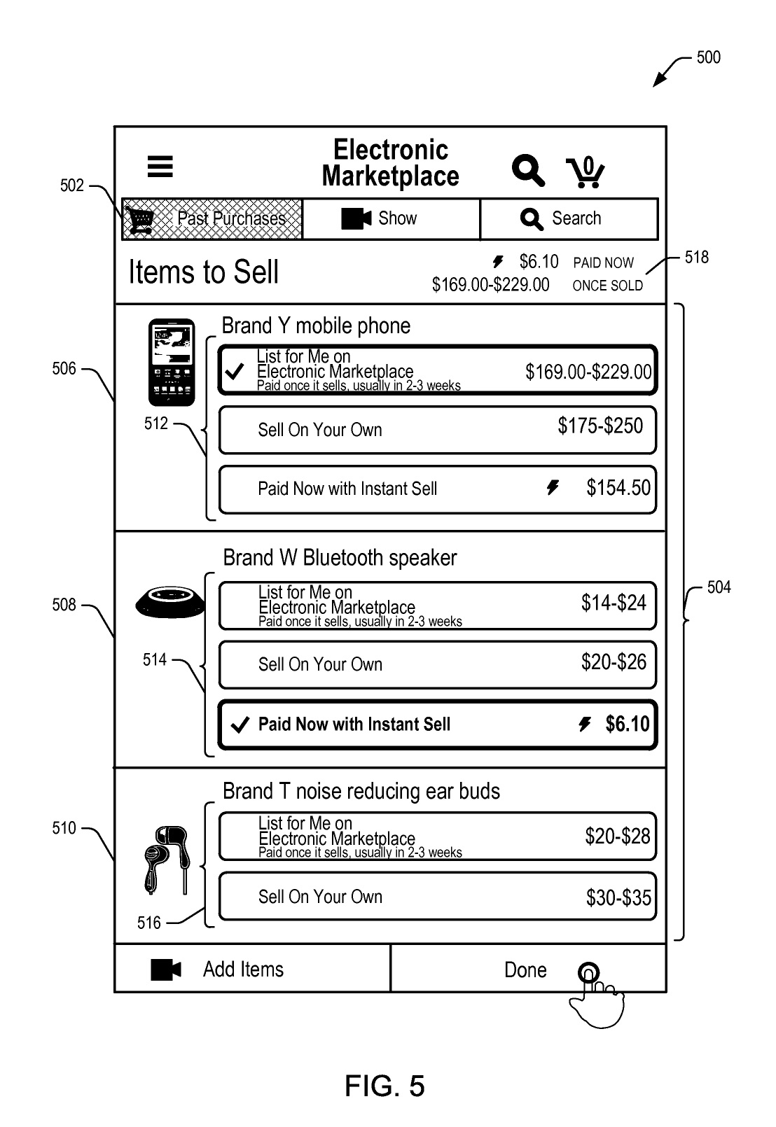

The option 402 includes text that reads: “Get $261 from past purchases.” In some examples, the text of the option 402 and the function associated with selecting the option 402, may be populated as the electronic marketplace 202 identifies items from the customer's purchase history that are eligible to be sold via an instant sell transaction. In this manner, the customer is presented with an exact amount of money that she could immediately receive for reselling items previously purchased. In some examples, the option 402 includes past purchases made in connection with the electronic marketplace 202. In some examples, the option 402 includes items possessed by the customers, but not purchased via the electronic marketplace. For example, the customer may notify the electronic marketplace 202 of these items, and the electronic marketplace 202 may determine whether the other items are eligible. If so, these other eligible items may be included in the option 402. In some examples, the option 402 may display the aggregate value of purchases made in connection with the electronic marketplace and the value of these other eligible items. In some examples, the information represented by the option 402 may be represented in a widget. For example, a selling widget may be placed on a home page associated with the electronic marketplace. The selling widget may function similar to a “digital shopping cart” widget, but instead of including items for purchase, the selling widget may include a list of eligible items and their associated possible values if sold across the different selling opportunities described herein (e.g., if sold via instant sell, via consignment, via sell-on-own). In this manner, the customer can weigh the trade-offs between the various opportunities. The selling widget may be dynamically updated to display the value of the list of eligible items if sold via the electronic marketplace, the number of eligible items, or any other suitable information. In some examples, the techniques described herein may analyze the customer's purchase history at a certain interval or in response to an event and update the selling widget accordingly. For example, the customer's purchase history may be analyzed each time the customer logs on to the electronic marketplace and the information represented by the selling widget may be updated. This may include adding or removing eligible items from the list of eligible items represented by the selling widget and updating the values associated with each of the eligible items and the aggregate value. In some examples, selection of the option 402 may direct the customer to another user interface to sell the customer's eligible items. Selection of the option 402 is discussed in more detail with reference to FIG. 5.

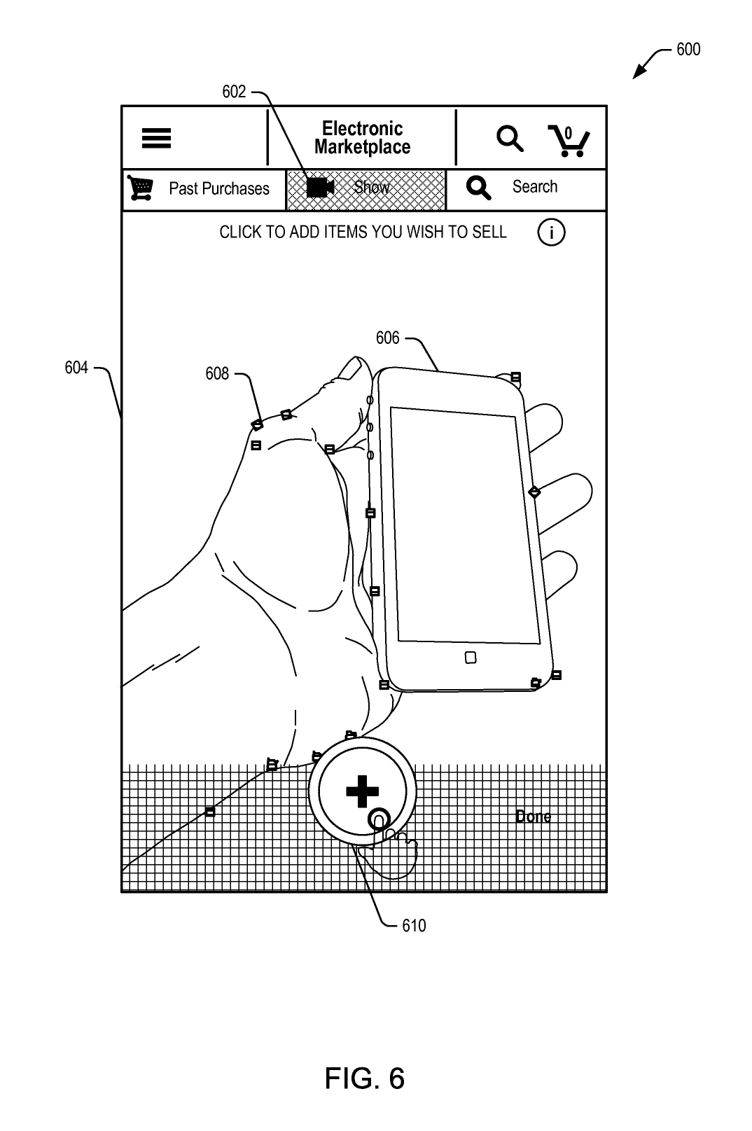

The option 404 includes text that reads: “Show us what you want to sell.” In some examples, selection of the option 404 may direct the customer to another user interface to use a camera associated with a user device on which the user interface 400 is being displayed to identify items which may be eligible. Selection of the option 404 is discussed in more detail with reference to FIG. 6.

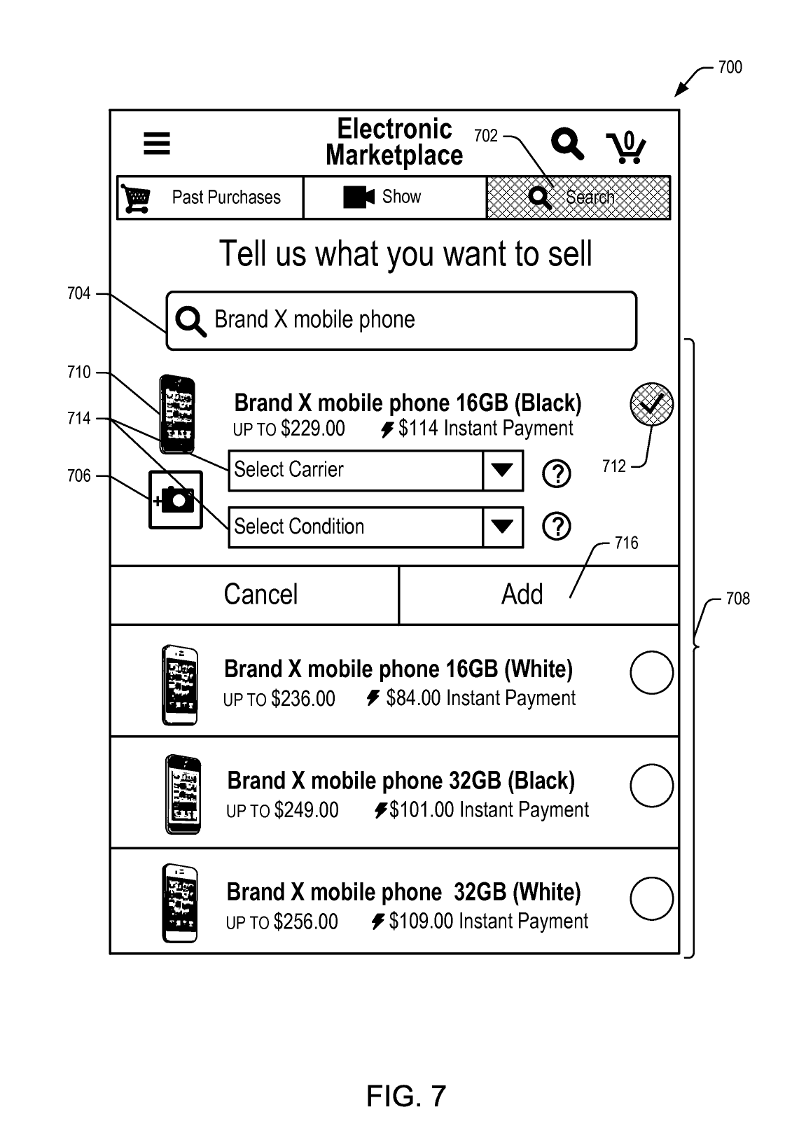

The option 406 includes text that reads: “Look up items to sell.” In some examples, selection of the option 406 may direct the customer to another user interface and enable the customer to search for eligible items. In some examples, the customer may select the option 406 if the item that the customer has in her possession and desires to sell was not known to the electronic marketplace 202 (e.g., the item was not purchased via the electronic marketplace 202). Selection of the option 406 is discussed in more detail with reference to FIG. 7. Selection of hyperlink 408 may enable the customer to learn more about selling her items in connection with the electronic marketplace 202.

FIG. 5 illustrates an example user interface 500 for implementing techniques relating to selling items in connection with an electronic marketplace as described herein. In particular, the user interface 500 may be a web-based user interface provided by the electronic marketplace 202 for presentation on the user device 204. A box 502 is highlighted along the top which may indicate that the user interface 500 presents information relating to past purchases. The user interface 500 may include a list of items to sell 504. The list 504 may be populated to include one or more items that the customer has previously purchased from the electronic marketplace 202. As illustrated in FIG. 5, the list 504 may include a first item 506, a second item 508, and a third item 510. The first item 506 may be a mobile phone. The mobile phone is identified by an image and other product details. Also associated with the first item 506 is a first list of selling opportunities 512. The first list of selling opportunities 512 may have been generated by the electronic marketplace 202 based on the customer indicating that she desires to sell previously-purchased items. In some examples, the first list of selling opportunities 512 is generated automatically or within a certain time period after an item has been purchased by the customer. For example, if customers generally sell their brand Y mobile phones 22 months after they purchase them, the electronic marketplace 202 may generate the first list of selling opportunities 512 without input from the customer and present it to the customer 22 months after the customer purchases the first item 506. The same can be said for any of other items in the list 504. In some examples, the list 504 may be generated in response to the customer requesting that the list 504 be generated. For example, the customer may not want to receive notifications regarding selling used or previously-purchased items. Instead, the customer may periodically request the electronic marketplace 202 to generate a list comparable to the list 504. The customer may then determine whether she wants to sell any of the items that may end up in the list. In some examples, the customers informs the electronic marketplace 202 of items purchased outside of the electronic marketplace 202. In this manner, the electronic marketplace 202 may be able to determine whether these other items are eligible and whether to include them in the list 504.

The first list of selling opportunities 512 may include one or more selling opportunities available for the customer to sell the first item 506. The one or more selling opportunities may be associated with one or more transaction types for selling the first item 506. In this example, the customer has selected the “List For Me on Electronic Marketplace” selling opportunity. The list for me opportunity is similar to a consignment opportunity where the electronic marketplace offers to sell the first item 512 on behalf of the customer. In this example, the customer may send the first item 512 to the electronic marketplace 202 and the electronic marketplace 202 may retain the first item 512 until it is sold. The electronic marketplace 202 may also provide for shipment of the first item 512 after it is sold. The consignment amount may be a percentage of the final sale price or a fixed amount. In this example, the customer is presented with a dollar range, i.e., $169-229, that the customer may receive if the first item 506 is sold under the list for me opportunity. In response to selection of the list for me opportunity, area 518 is updated to indicate that once the first item 506 is sold, the customer can expect to receive $169-$229. In some examples, the dollar range may be determined based on historical information relating to sales of items similar to the first item 506, predicted demand relating to items similar to the first item 506, and any other similar information.

The first list of selling opportunities 512 may also include a second selling opportunity, i.e., “Sell on Your Own,” which may enable the customer to sell the first item 506 on her own via the electronic marketplace 202. In some examples, this may include the customer setting the price and providing for shipment of the item. In some examples, the electronic marketplace 202 may collect a smaller fee for facilitating the sale, but which is much less than the consignment amount. Thus, a dollar range for the sell on your own opportunity may be greater than under the list for me option (e.g., $175-250).

The first list of selling opportunities 512 may also include a third selling opportunity, i.e., “Paid Now with Instant Sell,” which may enable the customer to sell the first item 506 to the electronic marketplace 202 in return for an immediate credit being applied to the customer's account. The details of the third selling opportunity will be discussed further with reference to the second item 508 including a second list of selling opportunities 514. Presentation of the third opportunity may depend on the customer being qualified and the first item 506 being eligible. Thus, because the third opportunity is presented the first item 506 has been determined to be eligible and the customer has been determined to be qualified.

The second list of selling opportunities 514 may include one or more opportunities available for the customer to sell the second item 508, which is a brand W speaker system that was previously purchased in connection with the electronic marketplace 202. The one or more opportunities may be associated with one or more transaction types for selling the second item 508. Similar to the first list of selling opportunities 512, the second list of selling opportunities 514 includes a list for me opportunity, a sell on your own opportunity, and an instant sell opportunity. The function of the three opportunities is similar for the second list of selling opportunities 514. In this example, the customer has selected the “Paid Now with Instant Sell” opportunity. In response to selection of the instant sell opportunity, the area 518 is updated to indicate that the customer is eligible to immediately receive $6.10. The lighting strike may indicate an instant sell amount. In some examples, the amount under the instant sell opportunity may be less than the amounts associated with the list for me opportunity (i.e., $14-$24) and the sell your own opportunity (e.g., $20-$26). This may be because the electronic marketplace 202 is offering immediate payment, offering to carry risk associated with the purchase, and is responsible brokering the transaction in which a merchant pays for and receives the second item 508. In some examples, the merchant is selected to purchase the second item 508 from the customer via the electronic marketplace 202 because the merchant submitted a bid for the second item 508, which was accepted when the customer accepted the instant sell opportunity. In some examples, the price of the second item 508 under the instant sell opportunity corresponds to a bid with the highest amount. In some examples, the electronic marketplace 202 considers other factors in determining the price associated with the instant sell opportunity. In some examples, a minimum price may be required for an item to be sold via the instant sell opportunity. For example, an item with a price less than $6.00 may not be eligible for instant sell. In some examples, a merchant bid may be automatically removed from the bidding platform if an item is selling cheaper than the merchant's bid) or in response to sudden inventory spikes. In some examples, merchants may be able to set an inventory target, and once this is met, their bid is taken down by the system.

A third list of selling opportunities 516 may include one or more opportunities available for the customer to sell the third item 508, which are brand T ear buds that were previously purchased in connection with the electronic marketplace 202. The one or more opportunities may be associated with one or more transaction types for selling the third item 506. Unlike the first list of selling opportunities 512 and the second list of selling opportunities 514, the third list of selling opportunities 516 may only include two opportunities: a list for me opportunity and a sell on your own opportunity. In some examples, this may be because, although the customer is qualified to sell items via the instant sell transaction, the third item 516 is not eligible for instant sell. This may be because there is not sufficient demand for the third item 516 or for other reasons (e.g., the third item 516 is a used personal item that was worn in a person's ears and is not generally resold for the instant sell transaction). In some examples, the customer may still sell the third item 516, just not using the instant sell option.

FIG. 6 illustrates an example user interface 600 for implementing techniques relating to selling items in connection with an electronic marketplace as described herein. In particular, the user interface 600 may be a web-based user interface provided by the electronic marketplace 202 for presentation on the user device 204. A box 602 is highlighted along the top which may indicate that the user interface 600 presents information relating to adding an item via an image. To this end, the user device 204 on which the user interface 600 is presented may include a camera. Window 604 may depict a view through the camera. Thus, the window 604 may include a mobile phone 606 and a customer's hand 608. In some examples, the electronic marketplace 202 may utilize image object detection techniques to identify the mobile phone 606. In some examples, the customer may interact with the window 604 to outline and/or select the mobile phone 606 as the object that the customer would like evaluated. In some examples, once the mobile phone 606 is outlined, the customer may select button 610 to add the mobile phone 606 to a list of items to sell. In some examples, adding the item to the list of items to sell via the camera may result in the same outcome as if the electronic marketplace 202 determined the mobile phone 606 by analyzing a purchase history of the customer.

In some examples, the user interface 600 may also enable the customer to input details about the mobile phone 606 via text input and/or voice input. For example, the customer may select a button which enables the customer to identify the condition by speaking (e.g., “the item is in good condition,” “the item is in acceptable condition,” or “the item is in like new condition”). In some examples, the condition of the mobile phone 606 is determined automatically by analyzing the image based on a set of condition criteria. In some examples, the customer is prompted to select the condition criteria relating to different aspects of the mobile phone 606. In some examples, the condition criteria may affect the price that the customer may sell the mobile phone. For example, regarding the display of the mobile phone 606, the customer may select which of the following best describes the mobile phone 606: “no flaws,” “scratches,” or “broken.” Regarding the body of the mobile phone 606, the customer may select which of the following best describes the mobile phone 606: “no flaws,” scratches,” or “cracked.” Regarding the accessories of the mobile phone 606, the customer may select which of the following best describes the mobile phone 606: “all, with box,” “all,” “some,” or “none.” Regarding personalization of the mobile phone 606, the customer may select which of the following best describes the mobile phone 606: “yes” or “no.”

FIG. 7 illustrates an example user interface 700 for implementing techniques relating to selling items in connection with an electronic marketplace as described herein. In particular, the user interface 700 may be a web-based user interface provided by the electronic marketplace 202 for presentation on the user device 204. A box 702 is highlighted along the top which may indicate that the user interface 700 presents information relating to adding an item via a search function. To this end, the user interface 700 may include a search bar 704. In this example, the customer has entered “brand X mobile phone” into the search bar 704. This may be because the customer has a brand X mobile phone in her possession that she desires to sell. In some examples, the customer can identify the brand X mobile phone that she has in her possession by selecting button 706 and adding the item via an image as discussed with reference to FIG. 6. In response to the search, the electronic marketplace 202 may return a list of search results 708. In some examples, the list of search results 708 is returned in response to the customer searching for goods at a different user interface unrelated to selling goods (e.g., at a homepage associated with the electronic marketplace 202). In this example, the opportunity to sell items may be presented to the customer as an opportunity along with opportunities to purchase other items. The list of search results 708 may relate to the search criteria entered in the search bar 704. For example, each result in the list of search results 708 is a brand X mobile phone. The difference between the results is the model of the brand X mobile phone (e.g., 16 GB (White), 16 GB (Black), etc.), and the possible prices. In some examples, the possible prices may correspond to the different opportunities for selling the first item 710. For example, details about the first item 710 indicate that the first item 710 may be sold for “up to $229.” This may be related to selling the item under a consignment opportunity or a sell on your own opportunity. The details may also indicate that, under an “instant payment” transaction, the first item 710 may be sold for “$114.” In this manner, the customer may be informed by the electronic marketplace 202 as to the amount of money or credit the customer could be entitled. The first item 710 has been selected by the customer selecting button 712. In response to selecting the first item 710, the customer may be presented additional options 714 relating the condition of the first item 710 and other details about the first item 710 (e.g., carrier, purchase date, personalization, defects, repairs, and any other suitable detail). In some examples, the additional options 714 may be defined as condition criteria relating to the condition of the first item 710. After the customer has selected the appropriate additional options 714, the customer may then add the first item 710 by selecting add button 716.

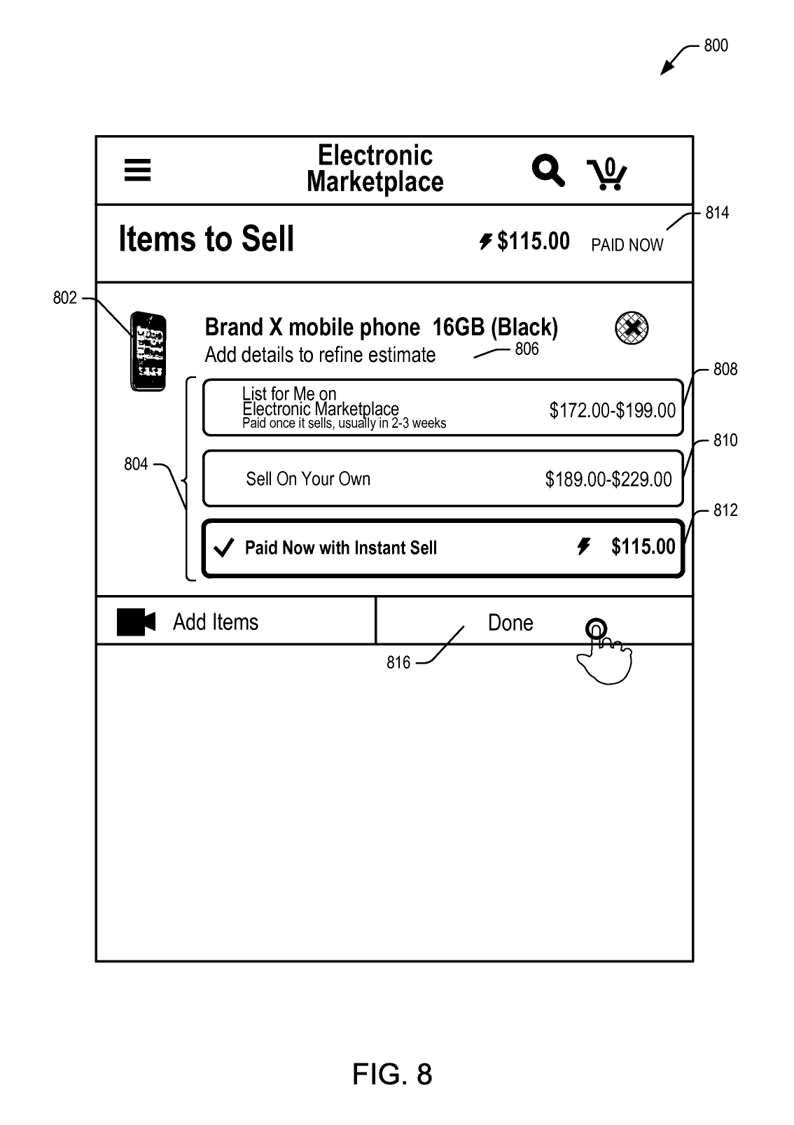

FIG. 8 illustrates an example user interface 800 for implementing techniques relating to selling items in connection with an electronic marketplace as described herein. In particular, the user interface 800 may be a web-based user interface provided by the electronic marketplace 202 for presentation on the user device 204. The user interface 800 may be presented to the customer (e.g., on the user device 204) in response to the customer selecting the add button 716 presented on the user interface 700, which adds the first item 710. In some examples, the user interface 800 may be presented to the customer in response to the customer uploading a captured image of the mobile phone 606 as discussed with reference to FIG. 6. Thus, item 802 may be an example of the first item 710 and/or the mobile phone 606. In any event, the user interface 800 may be used to present an offer 804 to the customer. The offer 804 may be related to selling the item 802. In some examples, the customer may select element 806 in order to add additional details about the item 802 that may affect an estimated price that the customer could receive for the item 802. Such additional details may include additional condition criteria, accessories, and any other information that may affect the estimated price.

Like other offers described herein, the offer 804 may include one or more opportunities for acceptance. Each of the one or more opportunities may correspond to a possible transaction type for accepting the offer 804. The conditions of the offer 804 may also depend on which transaction type is selected. For example, a first transaction type 808 is an example of a list for me opportunity and the customer could expect to receive between $172 and $199 if the first transaction type 808 is selected. A second transaction type 810 is an example of a sell on your own opportunity. Under this opportunity, the customer could expect to receive between $189 and $229 if the second transaction type 810 is selected. A third transaction type 812 is an example of an instant sell opportunity. Under this opportunity, the customer will receive $115 if the customer is qualified for instant payment. Upon final selection of the third transaction type 812, the customer's account will be credited $115. This amount may be provided to the customer's account in the form of a gift card redeemable in connection with the electronic marketplace 202 or in the form of any other suitable instrument. In this example, the customer has selected the third transaction type 812. Because of this area 814 is updated to reflect the amount the customer will receive under the third transaction type 812 (i.e., $115). Next, the customer may select a done button 816 and be presented with additional information.

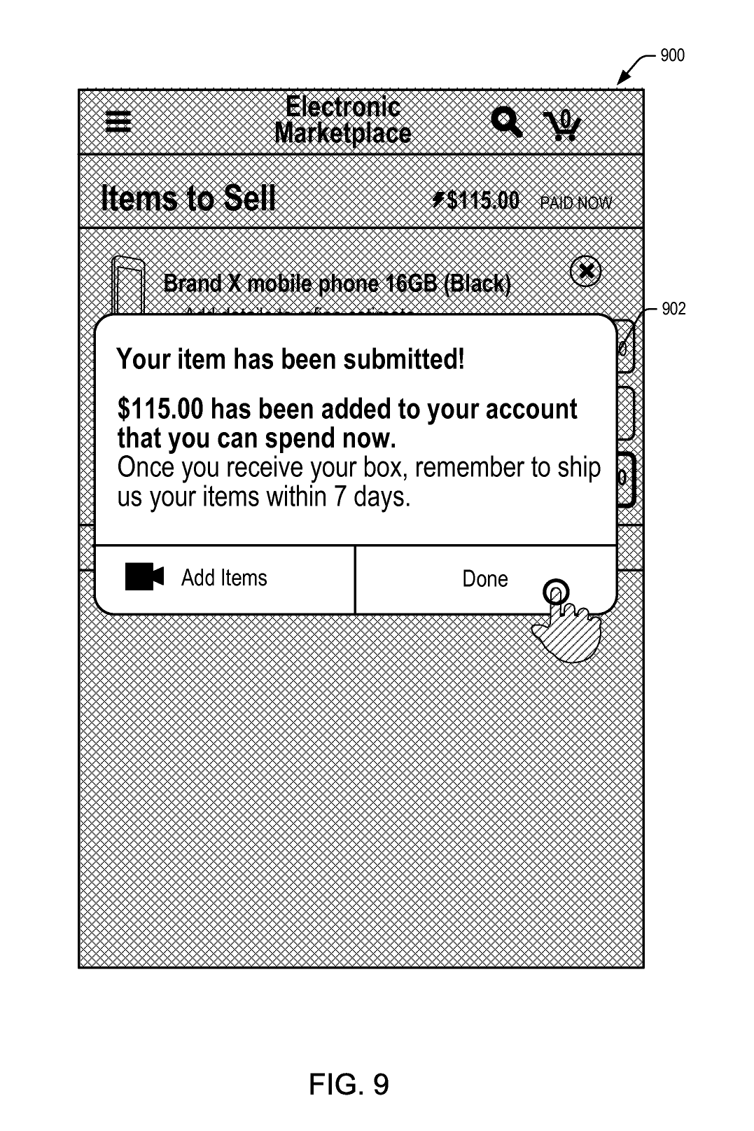

FIG. 9 illustrates an example user interface 900 for implementing techniques relating to selling items in connection with an electronic marketplace as described herein. In particular, the user interface 900 may be a web-based user interface provided by the electronic marketplace 202 for presentation on the user device 204. The user interface 900 may be presented to the customer (e.g., on the user device 204) in response to the customer selecting the done button 816 presented on the user interface 800. In response, a notification 902 may be presented to the customer. The notification 902 may include one or more instructions relating to the selected transaction and/or one or more terms or conditions relating to the selected transaction. For example, the notification 902 may indicate that $115 has been added to the customer's account and may be spent at any time. The notification 902 may also indicate shipping instructions reminding the customer to ship the selected item to the electronic marketplace within a fixed time period of 7 days. The notification 902 may also indicate that a box will be shipped to the customer to facilitate shipment of the item to the management entity associated with the electronic marketplace, or to the merchant directly.

Other instructions and other terms and conditions may also be presented in connection with the notification 902. For example, if the condition of the selected item is different than what the customer indicated, the customer may be required to cover the difference in value. For example, based on condition criteria either entered (e.g., via text or speech) or determined (e.g., from an image) and other information (e.g., popularity of the item), the electronic marketplace 202 may determine a price of $115. The electronic marketplace may also determine a trade-in condition score that corresponds to the submitted condition criteria. A condition agent associated with the electronic marketplace will receive the selected item and review the condition in light of the trade-in condition score. The condition agent may receive an instruction from the electronic marketplace to assess the condition of the item in light of the submitted condition criteria as evidenced by the trade-in condition score. The condition agent may assign a new condition score to the item. The new condition score may relate to the assessed condition criteria. For example, a brand new item may have a condition score of 100, while a used item with no commercial value remaining may have a condition score of 0. If the condition agent determines that the new condition score is less than the trade-in condition score or falls outside an expected range of condition scores based on the trade-in condition score, the condition agent may assess the value of the item lower. For example, the condition agent may determine that, contrary to the submitted condition criteria, the item has a cracked screen. Based on this, the condition agent may determine that the item has a lower condition score and therefore the value of item should be closer to $80. In this example, a credit instrument associated with the customer's account may be debited the difference between the initial price and the new price (e.g., $115-$80=$35).

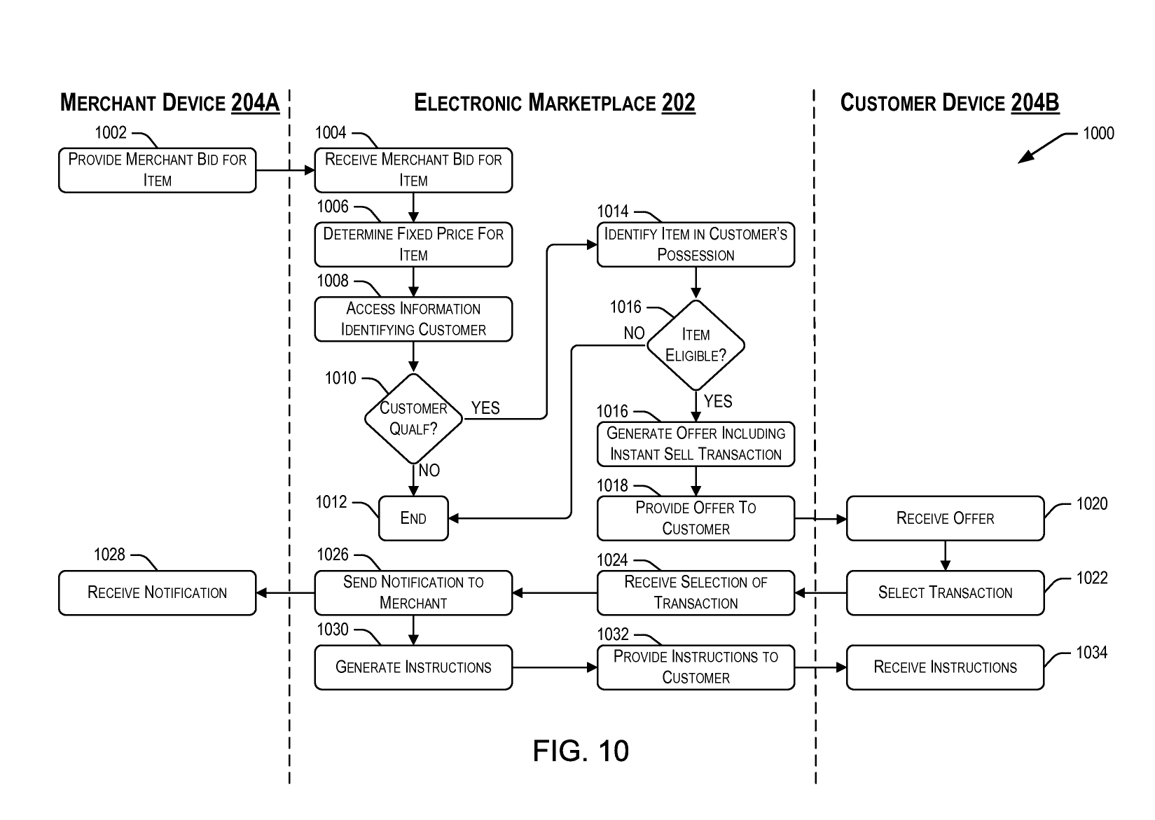

FIGS. 10, 11, and 12 illustrate example flow diagrams showing respective processes 1000, 1100, and 1200, as described herein. These processes 1000, 1100, and 1200 are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

FIG. 10 depicts the process 1000 including example acts or techniques relating to selling items in connection with an electronic marketplace in accordance with at least one example. The item management engine 102 (FIG. 1) within the electronic marketplace 202 (FIG. 2) and in communication with one or more user devices 204 (FIG. 2) may perform the process 1000 of FIG. 10. The process 1000 begins at 1002 by providing a merchant bid for an item. In some examples, providing the merchant bid for the item may be performed by a merchant device 204A, which is an example of the user device 204. In some examples, a merchant is enabled to provide the merchant bid using a bidding interface that receives bids for items, categories of items, and subcategories of items. In some examples, the merchant bid may be a standing bid for certain items based on one or more thresholds. For example, the merchant may indicate that it would like to purchase up to 100 brand X mobile phones, with a price per unit that does not exceed $100. In some examples, the merchant may be a merchant that buys and sells items in connection with the electronic marketplace 202.

At 1004, the process 1000 receives a merchant bid for an item. In some examples, receiving the merchant bid for the item may be performed by the merchant management module 304 (FIG. 3). The merchant bid may be received from the merchant associated with the merchant device 204A and may include a price that the merchant is willing to pay for the item. In some examples, receiving the merchant bid may include receiving a plurality of merchant bids from a plurality of merchants, with each bid including a price that a respective merchant is willing to pay for the item. In some examples, receiving the merchant bid for the item may include identifying a winning bid for the item. In some examples, the winning bid may be the highest bid received when more than one bid is received, or the only bid when only one bid is received.

At 1006, the process 1000 determines a fixed price for the item. In some examples, determining the fixed price may be performed by the merchant management module 304. Determining the fixed price for the item may include determining the fixed price based at least in part on the merchant bid. For example, the merchant bid may indicate that a merchant is willing to pay $500 for the item, and determining the fixed price may include determining, based at least in part on the an amount of $500, how much the electronic marketplace is willing to pay a customer to obtain the item to resell to the merchant. In some examples, the electronic marketplace may account for processing fees, taxes, shipping fees, and the like as they pertain to buying and selling the item. However, in some examples, the bid amount is the fixed price amount. In some examples, determining the fixed price may include determining the fixed price based at least in part on historical sales information for similar items.

At 1008, the process 1000 accesses information identifying a customer. In some examples, accessing the information identifying the customer may be performed by the customer qualification module 302 (FIG. 3). Identifying the customer may include accessing the customer information database 232 to identify a customer of the electronic marketplace. In some examples, identifying the customer may include receiving an indication that the customer has logged in to an account associated with the electronic marketplace. In some examples, the customer self identifies by informing the electronic marketplace that she would like a portion of the process 1000 to be performed on her behalf to determine whether she is qualified and whether any items in her possession are eligible.

At 1010, the process 1000 determines whether the customer is qualified. In some examples, determining whether the customer is qualified may be performed by the customer qualification module 302. Determining whether the customer is qualified may include accessing trust information associated with the customer and that indicates trustworthiness of the customer. The trust information may be retained in the data store 230 and/or accessed from other sources (e.g., credit evaluation agencies, fraud detection units of the electronic marketplace or operated by third parties, and any other suitable source). In some examples, the trust information may include account history information for the customer (e.g., length of time the account has been open, whether items have been purchased using the account, whether items have been returned using the account, whether the customer has multiple accounts, and any other suitable account history information), credit instrument information (e.g., whether the customer has a valid credit card on file with the account, a date on which the credit card expires, and any other suitable credit instrument information), access information (e.g., location information (e.g., geographic, IP addresses, and the like) relating to the customer device 204B or other user devices used to access the customer account), and any other suitable information that could be used to determine the trustworthiness of the customer. In some examples, the trustworthiness of the customer may correspond to a fraud risk profile for the customer. For example, a customer that is trustworthy may have a fraud risk profile that indicates that the customer presents a low fraud risk. In some examples, customers with low fraud risk profiles may be determined to be qualified to participate in certain services offered by the electronic marketplace. In particular, the qualified customers may sell items to the electronic marketplace using instant sell transactions including instant payment as described herein. In some examples, determining whether the customer is qualified may include accessing the qualified customer information database 236 to identify whether the customer is identified within the qualified customer information database 236 or whether the customer is disqualified.

If the answer at 1010 is NO, the process 1000 proceeds to 1012 where the process 1000 ends. In some examples, instead of ending, the process 1000 may continue to generate an offer for the item that does not include an instant sell transaction. This may be because, in this example, the instant sell transaction is offered only to qualified customers. If the answer at 1010 is YES, the process 1000 proceeds to 1014 where the process 1000 identifies that an item is in the customer's possession. In some examples, identifying that the item is in the customer's possession may be performed by the item eligibility module 306 (FIG. 3). Identifying the item may include accessing purchase history information for the customer to identify items that the customer may have in her possession. These items may be in her possession because they were previously purchased and the electronic marketplace has no record of them being sold or traded in. For example, the item eligibility module 306 may periodically review the customer's purchase history to identify a list of previously-purchased items. In some examples, identifying the item may include receiving an indication from the customer identifying the item. The indication may be in the form of an image depicting the item, as a selection of the item from a list of items presented on a user interface, or in any other suitable manner. In some examples, the list of items is a list of used items. In some examples, the list of items is presented in response to the customer searching a database of items. In some examples, the list of items may include used and new items, at least some of which may be available in connection with the electronic marketplace. In some examples, an option may be presented to the customer to sell her stuff, and identifying the item may include the customer selecting the sell your stuff option and indicating which items she'd like to sell.

At 1016, the process 1000 determines whether the item identified at 1014 is eligible. In some examples, determining whether the item is eligible may be performed by the item eligibility module 306. Determining whether the item is eligible may include determining whether the item is eligible to be sold in accordance with an instant sell transaction. In some examples, this determination may be based at least in part on popularity of the item. The popularity of the item may depend at least in part on historical purchase information for the item, historical trade-in information for the item, future demand for the item, historical glance information for the item, or any other suitable information. In some examples, the historical glance information may indicate customer interest in webpages of the electronic marketplace that describe aspects of the item. For example, the glance information may indicate the number of views for a detail page for the item compared to other items. In some examples, determining whether the item is eligible may be based at least in part on a time period in which the customer purchased the item. The time period may be determined based at least in part on information indicating when similar customers typically sell or trade in similar items. For example, if such information indicates that customers on average sell or trade in their brand W Bluetooth speakers 180 days after the speakers are purchased, and the customer purchased comparable (or the same model) Bluetooth speakers, the process 1000 may determine that the item is eligible for an instant sell transaction. In some examples, a purchase time period pertains more to when the offer is provided to the customer and not so much to eligibility. Thus, the time period may correspond to an average lifetime for items similar to the item. In some examples, the average lifetime may be determined based at least in part on historical purchase information for the similar items and historical trade-in information for the similar items.

If the answer at 1016 is NO, the process 1000 proceeds to 1012 where the process 1000 ends. If the answer at 1016 is YES, the process 1000 proceeds to 1016 where the process 1000 generates an offer including an instant sell transaction. In some examples, generating the offer including the instant sell transaction may be performed by the offer module 308 (FIG. 3). Generating the offer may include accessing the fixed price for the item determined at 1006 and accessing the eligible item determined at 1016. In some examples, the offer may be accepted via one or more transaction types. For example, the offer generated at 1016 may include the instant sell transaction. As described herein, the instant sell transaction may enable the customer to sell her item to the electronic marketplace in exchange for instant payment that may include an option for instant credit. In some examples, other transaction types may be included in the offer, at least some of the other transaction types may not require that the customer be qualified or that the item be eligible.

At 1018, the process 1000 provides the offer to the customer. In some examples, providing the offer to the customer may be performed by the offer module 308. Providing the offer may include providing the offer in response to the customer requesting the offer. Providing the offer may include providing the offer in the form of an email, as a customer-personalized widget on a webpage associated with the electronic marketplace, as a pop-up on a mobile device, on a checkout screen as the customer settles payment with the electronic marketplace for new items, any in any other suitable manner. In some examples, the offer is provided to the customer when the item associated with the offer is ripe for resell. For example, the offer may be provided to the customer without the customer requesting the offer. In this example, the electronic marketplace performs process 1000 and provides the offer to the customer after an average trade-in time has passed since the customer purchased the item. In some examples, the customer may indicate that she desires to receive the offer when an estimated price of the item falls within a certain range or relates to a threshold. For example, the customer may purchase an item for $250 and request that she be notified when an instant sell value of the item falls between $150-$160. In this example, the process 1000 provides the offer to the customer at a time when the requested condition is true (i.e., when the instant sell value of the item falls within the range of $150-$160). In this manner, the customer can plan when to sell items via the instant sell transaction without ongoing monitoring of items and without receiving offers from the electronic marketplace prior to the condition being true. In addition to a price condition, the customer may indicate a time condition. For example, the customer may indicate that she receive the offer 90 days after she purchases the item.

At 1020, the process 1000 receives the offer. In some examples, receiving the offer may be performed by the customer device 204B. Receiving the offer may be in response to the electronic marketplace providing the offer.

At 1022, the process 1000 selects a transaction. In some examples, selecting the transaction may be performed by the customer device 204B. Selecting the transaction may include the customer selecting, via the customer device 204B, the transaction from among one or more transactions associated with the offer. The transactions may each relate to a way that the customer can sell the item, as described herein.

At 1024, the process 1000 receives an indication of a selection of a transaction. In some examples, receiving the indication of the selection may be performed by the offer module 308. Receiving the indication may include receiving the selection that the customer made using the customer device 204B.

At 1026, the process 1000 provides a notification to a merchant. In some examples, providing the notification to the merchant may be performed by the merchant management module 304. Providing the notification to the merchant may include notifying the merchant that the merchant has won the item associated with the merchant bid. In some examples, the merchant is notified after the customer accepts the offer relating to selling the item. In some examples, sending the notification to the merchant may include generating a notification including a transaction identifier associated with a transaction in which the merchant receives legal ownership of the item in exchange of payment provided to the electronic marketplace. In some examples, the notification may include the transaction identifier, time stamps (e.g., when the bid was submitted, when the offer was accepted, and any other relevant times), an item identifier (e.g., UPC, ASIN, or any other suitable identifier), amount owed by the merchant for the item, any fees associated with the transaction, and any other suitable information.

At 1028, the process 1000 receives a notification. In some examples, receiving the notification may be performed by the merchant device 204A. In some examples, the notification is received from the electronic marketplace.

At 1030, the process 1000 generates instructions. In some examples, generating the instructions may be performed by the offer module 308. Generating the instructions may be in response to the customer accepting the offer. For example, once the customer accepts the offer and depending on which transaction type the customer accepts, the instructions may be generated. In some examples, the instructions indicate terms and conditions of accepting the offer, instructions for additional performance relating to the offer, and any other suitable instruction. For example, the instructions may indicate that the customer will shortly receive a box and shipping instruction for shipping the item. The instructions may also indicate the amount of credit the customer should expect in exchange for accepting the offer.

At 1032, the process 1000 provides instructions to a customer. In some examples, providing the instructions may be performed by the offer module 308. Providing the instructions may include sending the instructions to a user device associated with the customer.

At 1034, the process 1000 receives instructions. In some examples, receiving the instructions may be performed by the customer device 204B. Receiving the instructions may include receiving a notification that includes the instructions. In some examples, the notification may be provided in the form of a popup window, as part of a webpage, as an email, and in any other suitable manner.

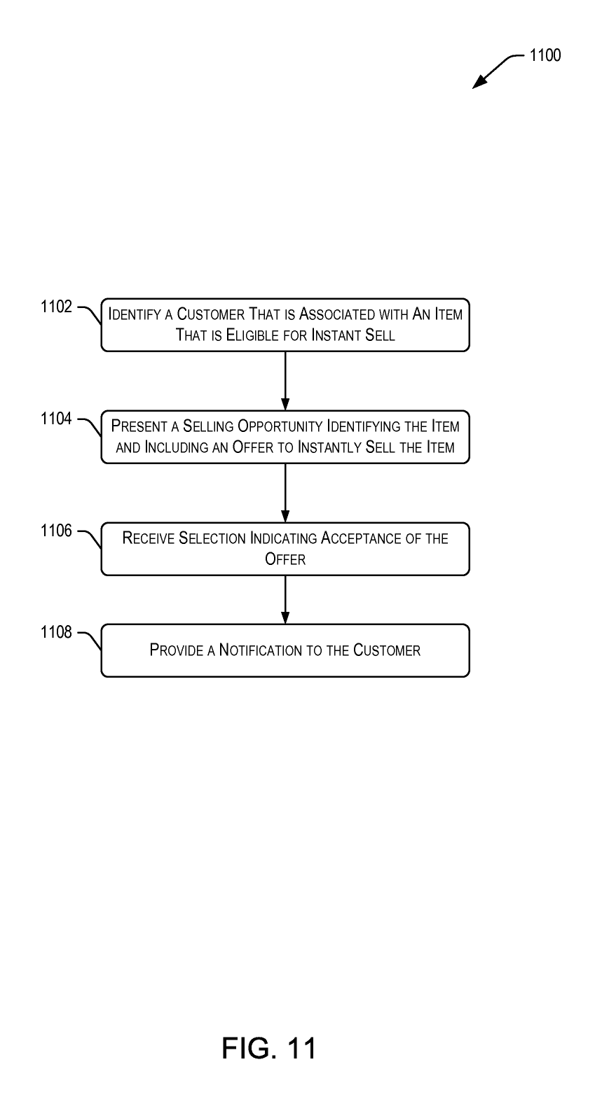

FIG. 11 depicts the process 1100 including example acts or techniques relating to selling items in connection with an electronic marketplace in accordance with at least one example. The item management engine 102 (FIG. 1) within the electronic marketplace 202 (FIG. 2) may perform the process 1100 of FIG. 11. The process 1100 begins at 1102 by identifying a customer that is associated with an item that is eligible for instant sell. In some examples, identifying the customer may be performed by the customer qualification module 302 (FIG. 302). Identifying the customer may include identifying the customer from a database of customers. In some examples, the customer may be identified because the customer has logged in to a customer account associated with the electronic marketplace. In some examples, it may be determined that the item is eligible for instant sell by accessing a database of eligible items. In some examples, the customer may send a message to the electronic marketplace requesting to sell items.

At 1104, the process 1100 presents a selling opportunity identifying the item and including an offer to instantly sell the item. In some examples, presenting the selling opportunity may be performed by the offer module 308 (FIG. 3). Presenting the selling opportunity including the offer to instantly sell the item may include providing the information for presentation on a user interface of a user device associated with the customer. In some examples, instantly selling the item may include disposing of the item via an instant sell transaction including instant payment. In some examples, the offer may include a fixed price for the item. The offer may also include terms of acceptance of the offer, a length of time that the offer remains valid, and any other suitable information to assist the customer in deciding whether to accept the offer. In some examples, presenting the selling opportunity may include presenting a list of selling opportunities with an instant sell opportunity including the offer. In some examples, the list of selling opportunities may include a consignment opportunity and a sell on own opportunity. In some examples, the offer may include a fixed price and can be accepted by user action without further consideration by the merchant. The offer may include item identification, price, condition requirement, and a time during which the offer will remain valid. If the fixed price changes during the time, the customer may be asked whether she wants to proceed with updated fixed price.

At 1106, the process 1100 receives selection indicating acceptance of the offer. In some examples, receiving selection indicating acceptance of the offer may be performed by the offer module 308. Receiving the selection may include receiving selection of a particular selling opportunity within a list of selling opportunities.

At 1108, the process 1000 provides a notification to the customer. In some examples, providing the notification may be performed by the offer module 308. The notification may include one or more instructions for complying with the selling opportunity, which may include shipping the item, receiving payment, and the like.

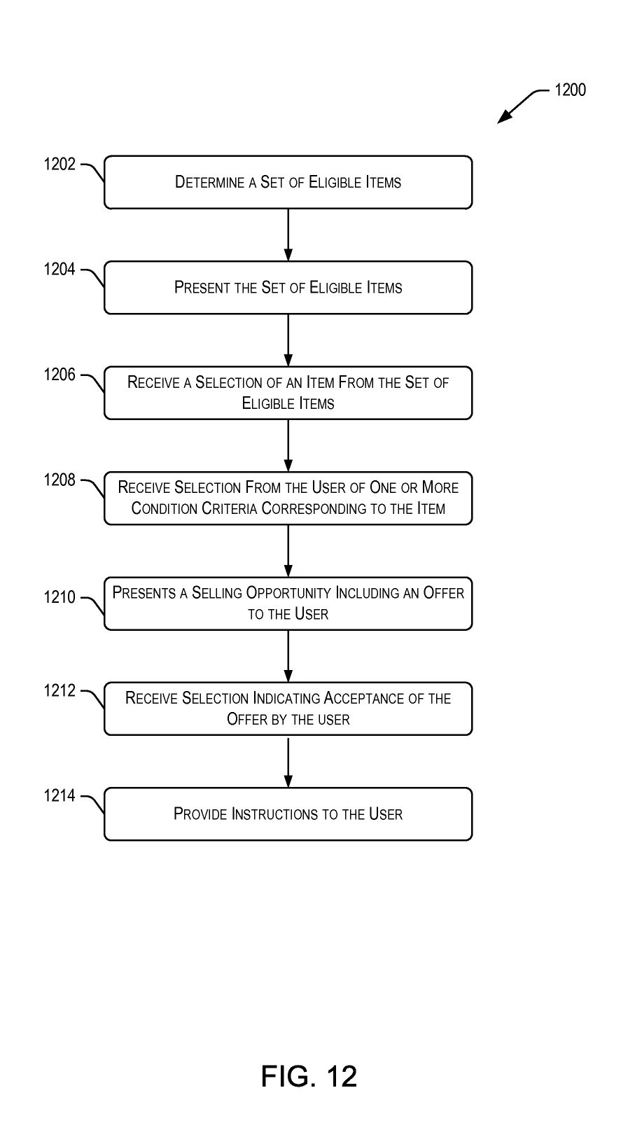

FIG. 12 depicts the process 1200 including example acts or techniques relating to selling items in connection with an electronic marketplace in accordance with at least one example. The item management engine 102 (FIG. 1) within the electronic marketplace 202 (FIG. 2) may perform the process 1200 of FIG. 12. The process 1200 begins at 1202 by determining a set of eligible items. In some examples, determining the set of eligible items may be performed by the item eligibility module 306 (FIG. 3). Determining the set of eligible items may be in response to the user entering a search term in a search box. In some examples, determining the set of eligible items is performed based at least in part on a purchase history of the user and a popularity of the set of eligible items with respect to the electronic marketplace. In some examples, the set of eligible items may be selected from an item database that includes a plurality of items available in connection with the electronic marketplace.

At 1204, the process 1200 presents the set of eligible items to a user. In some examples, presenting the set of eligible items may be performed by the item eligibility module 306. In some examples, presenting the set of eligible items to the user may include providing at least a portion of the set of eligible items for presentation on a user device associated with the user.

At 1206, the process 1200 receives selection from the user of an item of the set of eligible items. In some examples, receiving selection from the user of the item may be performed by the item eligibility module 306. The user may be in possession of the item.

At 1208, the process 1200 receives selection from the user of one or more condition criteria corresponding to the item. In some examples, receiving the selection of the one or more condition criteria may be performed by the item eligibility module 306. The one or more condition criteria may relate to the condition of the used item selected by the user at 1204. The condition criteria may relate to condition, personalization, accessories, and the like.

At 1210, the process 1200 presents a selling opportunity including an offer to the user. In some examples, presenting the selling opportunity may be performed by the offer module 308 (FIG. 3). In some examples, the offer may be an offer to the user to sell the item via an instant sell transaction. In some examples, the instant sell transaction may include instant payment. The offer may include a price that is determined based at least in part on the one or more condition criteria and eligibility information for the item. Presenting the selling opportunity including the offer may include providing the offer for presentation on a user interface of a user device associated with the user

At 1212, the process 1200 receives selection indicating acceptance of the offer by the user. In some examples, receiving selection indicating acceptance of the offer may be performed by the offer module 308.

At 1214, the process 1200 provides instructions to the user. In some examples, this may be performed by the offer module 308. Providing the instructions may include generating the instructions and providing to the user device.

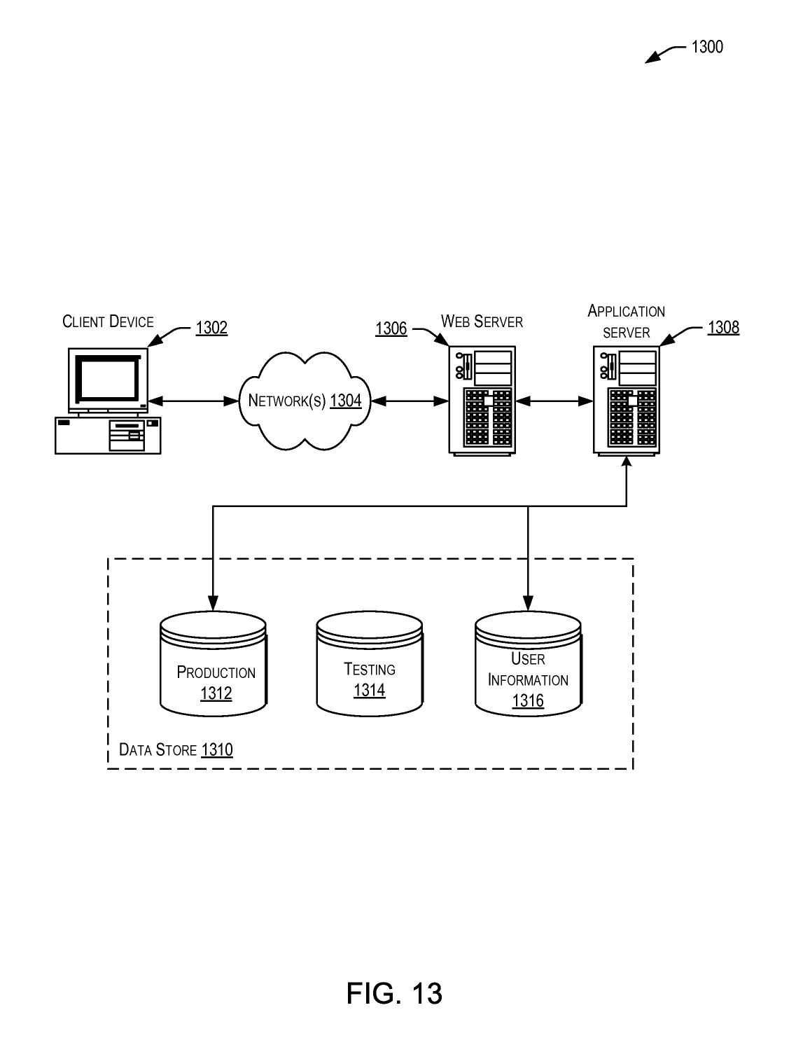

FIG. 13 illustrates aspects of an example environment 1300 for implementing aspects in accordance with various embodiments. As will be appreciated, although a Web-based environment is used for purposes of explanation, different environments may be used, as appropriate, to implement various embodiments. The environment includes an electronic client device 1302, which can include any appropriate device operable to send and receive requests, messages, or information over an appropriate network 1304 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1306 for receiving requests and serving content in response thereto, although for other networks an alternative device serving a similar purpose could be used as would be apparent to one of ordinary skill in the art.

The illustrative environment includes at least one application server 1308 and a data store 1310. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 1302 and the application server 1308, can be handled by the Web server. It should be understood that the Web and application servers are not required and are merely example components, as structured code discussed herein can be executed on any appropriate device or host machine as discussed elsewhere herein.

The data store 1310 can include several separate data tables, databases or other data storage mechanisms and media for storing data relating to a particular aspect. For example, the data store illustrated includes mechanisms for storing production data 1312 and user information 1316, which can be used to serve content for the production side. The data store also is shown to include a mechanism for storing log data 1314, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1310. The data store 1310 is operable, through logic associated therewith, to receive instructions from the application server 1308 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the client device 1302. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 13. Thus, the depiction of the environment 1300 in FIG. 13 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media may include computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. One or more computer-readable storage devices for storing computer-executable instructions that, when executed by one or more computer systems, configure the one or more computer systems to perform operations, comprising:
maintaining an item database including eligible items, the eligible items selected to be included in the item database based at least in part on popularity of the eligible items with respect to an electronic marketplace;
identifying a customer of the electronic marketplace that is in possession of at least one of the eligible items based at least in part on a purchase history of the customer;
identifying a time of purchase when the customer purchased the at least one eligible item;
receiving condition information indicating a condition of the at least one eligible item;
presenting, on a user device of the customer and based at least in part on the time of purchase, a selling opportunity including an offer to the customer to sell the at least one eligible item to a purchasing party for a fixed price, the fixed price determined based at least in part on the condition information;
receiving, via the user device, a selection indicating acceptance of the offer; and
in response to receiving the selection, crediting a customer account of the customer an amount equal to the fixed price.

2. The one or more computer-readable storage devices claim 1, wherein the purchasing party comprises at least one of a third-party merchant or a purchasing entity of the electronic marketplace, and wherein, after receiving the selection indicating acceptance, the electronic marketplace enables the purchasing party to purchase the at least one eligible item from the customer for the fixed price when a merchant bid of the purchasing party is determined to be a winning bid.

3. The one or more computer-readable storage devices claim 1, wherein the operations further comprise presenting a second selling opportunity to the customer to allow the electronic marketplace to sell the at least one eligible item on behalf of the customer, the second selling opportunity including a range of possible prices for the at least one eligible item, and wherein the selection indicating acceptance of the offer comprises a selection of the offer via a user interface of a user device of the customer after the selling opportunity and the second selling opportunity have been presented.

4. The one or more computer-readable storage devices claim 1, wherein the popularity of the eligible items is determined based in part on one or more of historical purchase information for the eligible items, historical resell information for the eligible items, future demand for the eligible items, or historical glance information for the eligible items, the historical glance information indicating customer interest in webpages of the electronic marketplace that describe aspects of the eligible items.

5. The one or more computer-readable storage devices claim 1, wherein presenting the offer comprises presenting the offer based at least in part on a relationship between the time of purchase and an average lifetime for items similar to the at least one eligible item, the average lifetime determined based at least in part on historical purchase information for the similar items and historical resell information for the similar items.

6. A computer-implemented method, comprising:
identifying a customer that is associated with an item that is eligible for instant sell, the item determined to be eligible for instant sell based at least in part on popularity of the item with respect to an electronic marketplace;
presenting, on a user device and based at least in part on a time when the item was purchased, one or more selling opportunities for the customer to sell the item, a first selling opportunity of the one or more selling opportunities comprising an offer for the customer to sell the item via an instant payment transaction when the customer is qualified for the instant payment transaction;
receiving a selection indicating acceptance of the offer by the customer; and
providing a notification to the customer via the user device, the notification generated in accordance with the acceptance of the offer.

7. The computer-implemented method of claim 6, wherein the popularity of the item with respect to the electronic marketplace is determined based in part on one or more of historical purchase information for the item, future demand for the item, historical trade-in information for item, or historical glance information for the item, the historical glance information indicating customer interest in one or more webpages of the electronic marketplace that describe aspects of the item.

8. The computer-implemented method of claim 6, further comprising accessing customer information indicating the time when the item was purchased, the time falling within an eligibility time period for the item, and the eligibility time period corresponding to an average lifetime for items similar to the item, the average lifetime determined based at least in part on historical purchase information for the similar items and historical resell information for the similar items, and wherein the item is determined to be eligible for instant sell based at least in part on the popularity of the item and the customer information.

9. The computer-implemented method of claim 6, further comprising receiving an indication from the customer identifying the item and the time when the item was purchased.

10. The computer-implemented method of claim 9, wherein the indication is received in response to the customer selecting the item from a list of items populated in response to a search within an item database associated with the electronic marketplace, or is received in response to the customer uploading an image depicting the item to the electronic marketplace.

11. The computer-implemented method of claim 6, further comprising, prior to presenting the one or more selling opportunities, determining whether the customer is qualified for the instant payment transaction by accessing trust information associated with the customer, the trust information indicating trustworthiness of the customer and comprising at least one of customer account history information for a customer account associated with the electronic marketplace and belonging to the customer, credit instrument information for the customer, or device location information for the user device of the customer used to access the electronic marketplace.

12. The computer-implemented method of claim 6, wherein the item comprises a used item, the method further comprising:
receiving a selection from the customer of one or more condition criteria corresponding to the used item;
receiving one or more merchant bids for the used item from one or more merchants associated with the electronic marketplace; and
determining, based at least in part on the one or more condition criteria and the one or more merchant bids, a fixed price for the instant sell transaction.

13. The computer-implemented method of claim 12, further comprising, in response to receiving the selection indicating acceptance of the offer, crediting a customer account of the customer an amount equal to the fixed price.

14. The computer-implemented method of claim 6, wherein the notification comprises shipping instructions for shipping the item and a summary of the acceptance of the offer.

15. The computer-implemented method of claim 6, wherein presenting the information identifying the item on the user device comprises presenting the information via a widget on a webpage associated with the electronic marketplace in response to the customer logging into a customer account associated with the electronic marketplace or via an email provided to the customer.

16. The computer-implemented method of claim 6, wherein presenting the one or more selling opportunities for the customer to sell the item comprises presenting a second selling opportunity and a third selling opportunity, the second selling opportunity associated with a first range of possible prices and, if selected, allowing the electronic marketplace to sell the item via a consignment transaction, and the third selling opportunity associated with a second range of possible prices and, if selected, allowing the customer to sell the item via a sell on own transaction and wherein the selection indicating acceptance of the offer comprises a selection indicating acceptance of the offer after the first selling opportunity, the second selling opportunity, and the third selling opportunity have been presented.

17. A system, comprising:
a user database including users associated with an electronic marketplace;
an item database including a plurality of items associated with the electronic marketplace; and
the electronic marketplace in communication with the user database and the item database, the electronic marketplace configured with at least a memory and a processor configured to:
determine a set of eligible items from the item database, each of the eligible items associated with a user of the electronic marketplace, the set of eligible items determined based at least in part on a purchase history associated with the user and a popularity of the set of eligible items with respect to the electronic marketplace;
present the set of eligible items identified from the item database to the user;
receive a selection from the user of an item from the set of eligible items, the user in possession of the item;
receive a selection from the user of one or more condition criteria corresponding to the item;
present a selling opportunity including an offer to the user, the offer determined based at least in part on the one or more condition criteria;
receive a selection indicating acceptance of the offer by the user; and
provide instructions to the user, the instructions generated in accordance with the acceptance of the offer.

18. The system of claim 17, wherein the electronic marketplace is further configured to:
receive a plurality of merchant bids from a plurality of merchants associated with the electronic marketplace;
determine a winning bid from among the plurality of bids, the winning bid associated with a fixed price that is presented in association with the offer; and
in response to receiving the selection indicating the acceptance of the offer, enabling a merchant of the plurality of merchants that provided the winning bid to receive the item from the user.

19. The system of claim 17, wherein the purchase history comprises first historical information for a first subset of the set of eligible items that was acquired by the customer via the electronic marketplace and second historical information for a second subset of the set of eligible items that was acquired by the customer outside of the electronic marketplace.

20. The system of claim 17, wherein the instructions instruct the user to send the item to a condition entity associated with the electronic marketplace, and wherein the electronic marketplace is further configured to:
provide condition instructions to a human operator at the condition entity, the condition instructions instructing the human operator to assess a condition of the item based at least in part on the one or more condition criteria;
receive a condition score for the item from the human operator; and
debiting a user account of the user when the condition score falls below a threshold associated with the one or more condition criteria.
